(19) United States
(12) Patent Application Publication
(10) Pub. No.: US 2008/0046640 A1
(43) Pub. Date: Feb. 21, 2008

(54) Memory system with reduced standby current

(76) Inventor: Sang-Guk Han, Hwaseong-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/797,987

(22) Filed: May 9, 2007

(30) Foreign Application Priority Data
Jun. 26, 2006 (KR) 10-2006-0057698

(51) Int. Cl. G06F 12/00

(52) U.S. Cl. 711/103

(57) ABSTRACT

Provided is a memory system receiving an external supply voltage from a host. The memory system includes a plurality of flash memories, a memory controller generating a respective chip selection signals respectively selecting one or more of the plurality of the flash memories in response to a request from the host, and a switch controlling supply of the external supply voltage to at least one of the plurality of flash memories in response to at least one of the chip selection signals.

### CROSS-REFERENCE TO RELATED APPLICATIONS

This patent application claims priority under 35 U.S.C. § 119 to Korean Patent Application No. 10-2006-0057698 filed on Jun. 26, 2006, the subject matter of which is hereby incorporated by reference.

### BACKGROUND OF THE INVENTION

The present invention relates to memory systems and semiconductor memory devices use in memory systems.

Memory cards are commonly used to store digital data in a variety of products such as consumer electronics. Examples of the memory cards include flash cards including flash type or other electrically erasable/programmable read only memory (EEPROM) types. Flash cards have a relatively small size and have been used to store digital data in a variety of products such as digital cameras, portable computers, settop boxes, and portable or other small-sized audio players/recorders (e.g., MP3 devices, portable multimedia players (PMPs)).

The demand for high capacity memory cards has increased with the increasingly popularity of these products. The data storage capacity provided by a memory card may be increased by adding additional memory. However, in many conventional memory card architectures, the standby current consumed by the memory card has gradually increased with increased data storage capacity. As a result, the battery life (i.e., the standby operating availability) of many portable products incorporating memory cards has been reduced. This outcome is very undesirable, since standby operating availability and the provision of battery power to contemporary products, particularly small, consumer portable products, is an important market distinction. As result, higher performance memory cards having reduced standby current are diligently being sought.

### SUMMARY OF THE INVENTION

Embodiments of the invention provide a memory system having reduced standby current.

In one embodiment, the invention provides a memory system receiving an external supply voltage from a host, the memory system comprising; a plurality of flash memories, a memory controller generating a respective chip selection signal respectively selecting one or more of the plurality of the flash memories in response to a request from the host, and a switch controlling supply of the external supply voltage to at least one of the plurality of flash memories in response to at least one of the chip selection signals.

In another embodiment, the invention provides a method for reducing a standby current in a memory system having a plurality of flash memories supplied with an external supply voltage from a host, the method comprising; receiving a request from the host and identifying one or more selected flash memories associated with the request, and selectively supplying the external supply voltage to the one or more selected flash memories via a switch.

### BRIEF DESCRIPTION OF THE FIGURES

FIG. 1 is a block diagram of a memory system according to an embodiment of the present invention.

FIG. 2 is a block diagram of a memory system according to another embodiment of the present invention.

FIG. 3 is a circuit diagram of the switch circuit shown in FIG. 1.

FIGS. 4 and 5 are block diagrams of a memory system according to another embodiment of the present invention.

### DESCRIPTION OF EMBODIMENTS

Embodiments of the invention will now be described with reference to the accompanying drawings. Throughout the written description and drawings, like reference numerals refer to like or similar elements. Although the invention is taught in the context of the following embodiments, the invention may be variously embodied and should not be constructed as being limited to only the illustrated embodiments.

Exemplary memory systems incorporating one or more memory cards will be described in the following embodiments. Those of ordinary skill in the art will appreciate advantages and certain performance features of the present invention from this description, but will also understand that many other types and configurations of memory systems will benefit from such advantages and features.

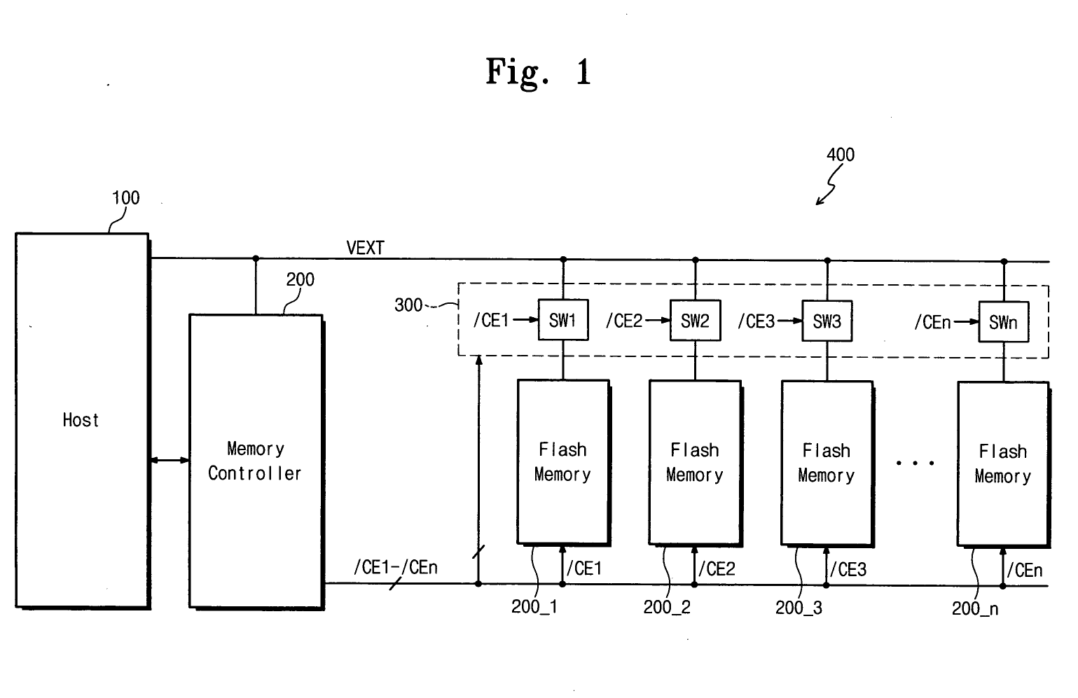

FIG. 1 is a block diagram of a memory system according to an embodiment of the present invention.

Referring to FIG. 1, the memory system includes a memory card 400 associated with a host 100. The connection of memory card 400 may be realized via an interface with host 100 through various hardware (or wireless) connections and through various data and command protocols. Many of these connections and protocols are the subject of industry standards. For example, in one embodiment, memory card 400 may take the form of a personal computer (PC) memory card, such as a memory card implemented according to the Personal Computer Memory Card International Association (PCMCIA) standard. Memory card 400 might also take the form of flash card, a flash disk, a multimedia card, and an Advanced Technology Attachment (ATA) card, etc. Alternately, the functional capabilities of memory card 400 might be implemented in other than a memory card configuration (i.e., the constituent memory devices might be mounted directly on a main or auxiliary printed circuits board within host 100).

However, in the illustrated example of FIG. 1, memory card 400 is assumed to receive an externally supplied power voltage (VEXT) from host 100. Memory card 400 includes a memory controller 200 and a plurality of flash memories 200_1-200_{—}n. Memory controller 200 commonly provides control, data, and/or address data to flash memories 200_0 through 200_{—}n. Memory controller 200 may be implemented from a class of well known control circuits adapted for used with the plurality of flash memories 200_1-200_{—}n in response to a request from host 100. Said “request” may take many forms, but will usually be resolved as one or more memory system operations (e.g., read, write (or program), and erase). For example, memory controller 200 may activate a first chip selection signal (/CE1) and apply it to flash memory 200_1 when performing a memory system operation in relation to data stored in flash memory 200_1. During the activation of the first chip selection signal, other chip selection signals (e.g., /CE2 through /CEn) corresponding to flash memories 200_2 through 200_{—}n are deactivated.

Referring still to FIG. 1, memory card 400 further includes a switch 300 operating in response to the plurality of chip selection signals (/CE1 through /CEn). In the illustrated example of FIG. 1, switch 300 includes a plurality of switch elements SW1 through SWn corresponding respectively to the plurality of flash memories 200_1 though 200_{—}n. Each one of the plurality of switch elements SW1 through SWn is controlled to a corresponding chip selection signal /CE1 through /CEn

With this configuration, switch 300 selectively supplies the external supply voltage (VEXT) provided by host 100 to flash memories 200_1 through 200_{—}n in response to the respective chip selection signals (/CE1 through /CEn). For example, when the first chip selection signal /CE1 is activated, switch 300 supplies the external supply voltage (VEXT) to flash memory 200_1, and deactivates (switch off) the supply of the external supply voltage (VEXT) to the other flash memories 200_2 through 200_{—}n. Of note, one or more of the plurality of chip selection signals (/CE1 though /CEn) may be individually or simultaneously activated in accordance with a memory system operating mode.

During operation of the memory system, the external supply voltage (VEXT) is supplied to memory controller 200 and switch 300 when memory card 400 is connected to host 100. After that, when a memory system operation associated with flash memory 200_1 is requested by host 100, memory controller 200 activates the first chip selection signal (/CE1) and deactivates the other chip selection signals (/CE2 through /CEn). The external supply voltage (VEXT) is supplied to flash memory 200_1 via first switch element SW1 since the first chip selection signal (/CE1) is activated. Simultaneously, since the other chip selection signals (/CE2 through /CEn) are deactivated, switch 300 prevents application of the external supply voltage (VEXT) to the other flash memories 200_2 through 200_{—}n. As a result, any standby current otherwise consumed by the other (unselected) flash memories 200_2 through 200_{—}n is reduced or eliminated. When the requested operation associated with flash memory 200_1 is completed, memory controller 200 deactivates the first chip selection signal (/CE1).

Thus, in certain operating modes of the memory system, the external supply voltage (VEXT) is supplied to a single selected flash memory associated with a memory system operation identified by the host request. The external supply voltage (VEXT) is cut off from the other unselected flash memories mounted on memory card 400 by switch 300. Therefore, any standby current that would be unnecessarily consumed by the unselected flash memories is reduced or eliminated. The reduction in standby current is proportional to a data storage capacity (i.e., number of potentially unselected flash memories) of memory card 400.

Additionally, memory controller 200 may be implemented with the capability to communicate standby state information associated with memory card 400 to host 100. In one embodiment, this standby state information may be provided as an interrupt to host 100 when access to the memory system by host 100 is infrequent, or when all of the chip selection signals associated with the plurality of flash memories have been deactivated for a predetermined period of time. In response to the standby state information, host 100 may completely cut off the external supply voltage (VEXT) supplied to memory card 400 during a standby mode of operation. Consequently, a standby current consumption by memory card 400 may be further reduced during standby mode.

Returning to the example of FIG. 1, the plurality of switch elements SW1 to SWn forming switch 300 may be realized using individual devices connected to the printed circuit board implementing memory card 400. Alternately, switch 300 may be implemented within memory controller 200 or a separately provided control circuit.

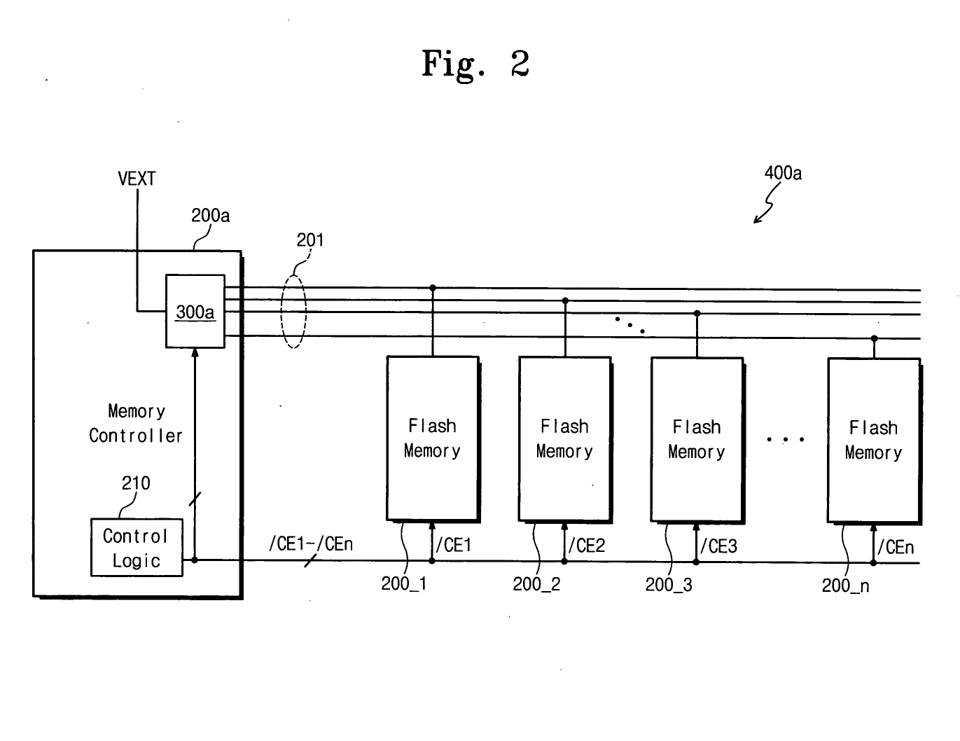

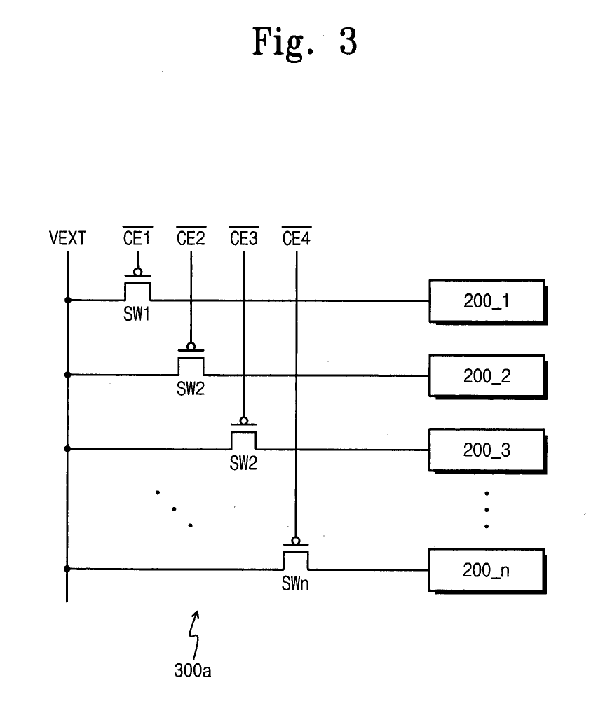

For example, in the alternate embodiment shown in FIG. 2 (and in some additional detail in FIG. 3), switch 300s is realized in memory controller 200a using p-type metal oxide semiconductor (PMOS) transistors to implement switch elements SW1 through SWn, each correspondingly associated with one of the plurality of flash memories 200_1 through 200_{—}n. The PMOS transistors implementing the switch elements SW1 though SWn are each controlled by corresponding chip selection signals (/CE1 through /CEn). Switch 300a may be controlled in its operation within memory controller 200a by control logic 210.

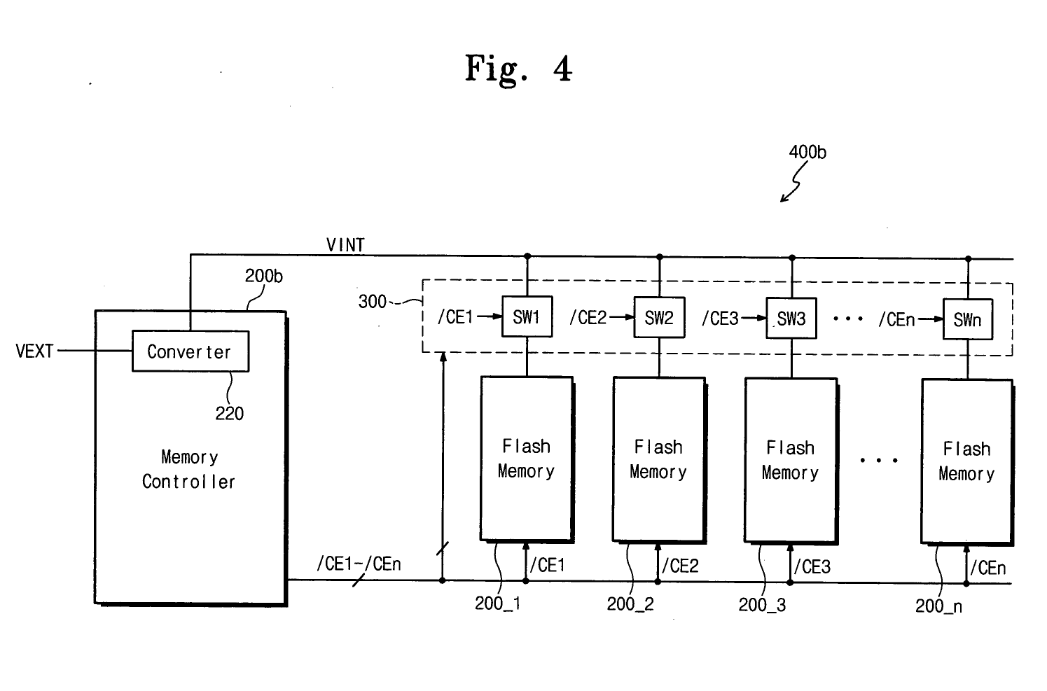

FIG. 4 is a block diagram of a memory system according to another embodiment of the present invention.

Referring to FIG. 4, the memory system includes memory card 400b and memory controller 200b. Memory card 400b includes a plurality of flash memories 200_1 through 200_{—}n and switch 300. Additionally, memory controller 200b includes a voltage converting circuit 220 for converting the external supply voltage VEXT received from host 100 into an internal supply voltage (VINT) applied to switch 300. Voltage converting circuit 220 may be conventional in its implementation and may adjust the amplitude, frequency, phase and/or timing of the external supply voltage (EXT) to properly conform to the operating requirements of memory system 400b.

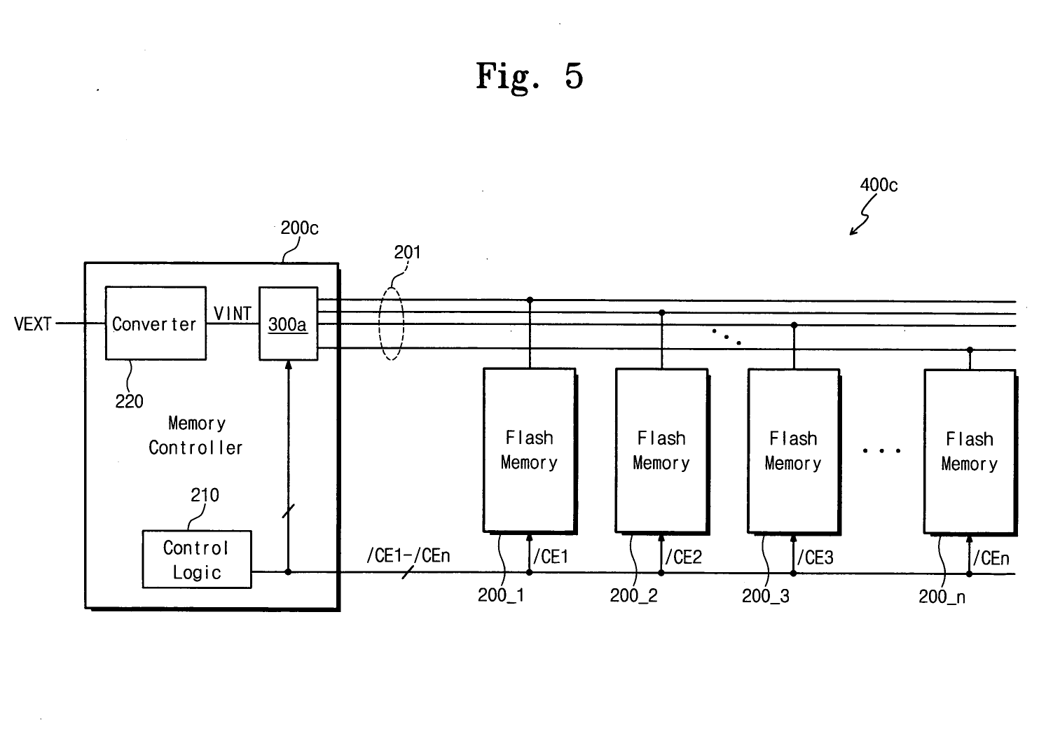

As another possible embodiment switch 300 shown in FIG. 4 might be incorporated into memory controller 200c. In this case, as shown in FIG. 5, the internal supply voltage (VINT) provided by voltage converting circuit 220 is applied to switch 300a within memory controller 200c. Switch 300a may be operated under the control of control logic 210. From switch 300a, a plurality of voltage supply lines 201 may be run to the plurality of flash memories, 200_1 through 200_{—}n.

Each of the foregoing embodiments allows a significant reduction in standby current consumption associated with the memory card by cutting off power supplied to the various flash memories when not needed by an ongoing operation.

As will be understood by those skilled in the art, the foregoing embodiments may be variously modified and altered. For example, DRAM or SRAM memories might be configured additionally or alternately with the plurality of flash memories. Such modifications and alterations fall within the scope of the present invention which is defined by the following claims.

What is claimed is:

1. A memory system receiving an external supply voltage from a host, the memory system comprising:
a plurality of flash memories;
a memory controller generating a respective chip selection signal respectively selecting one or more of the plurality of the flash memories in response to a request from the host; and
a switch controlling supply of the external supply voltage to at least one of the plurality of flash memories in response to at least one of the chip selection signals.

2. The memory system of claim 1, wherein in response to the request from the host, a first chip selection signal is activated and other chips selection signals are deactivated such that the external supply voltage is supplied to one of the plurality of flash memories and is cut off from other ones of the plurality of flash memories.

3. The memory system of claim 1, wherein the plurality of flash memories are configured on a memory card.

4. The memory system of claim 1, wherein the switch comprises a plurality of switch elements respectively corresponding to each one of the plurality of flash memories, wherein each one of the plurality of switch elements is controlled by a corresponding chip selection signal.

5. The memory system of claim 4, wherein each of the switch elements comprises a discrete switch device directly mounted on a printed circuit board additionally mounting the plurality of flash memories.

6. The memory system of claim 1, wherein the switch is implemented within the memory controller.

7. The memory system of claim 6, wherein the switch provides the external supply voltage to each one of the plurality of flash memories via one of a plurality of power lines in response to a corresponding chip selection signal.

8. The memory system of claim 6, wherein the memory controller further comprises a voltage converting circuit receiving the external supply voltage and generating an internal supply voltage from the external supply voltage and applying the internal supply voltage to the switch.

9. The memory system of claim 8, wherein the switch provides the external supply voltage to each one of the plurality of flash memories via one of a plurality of power lines in response to a corresponding chip selection signal.

10. The memory system of claim 1, wherein the memory controller provides an interrupt to the host indicating standby state information.

11. The memory system of claim 10, wherein the host cuts off the external supply voltage in response to the interrupt received from the memory controller.

12. A method for reducing a standby current in a memory system having a plurality of flash memories supplied with an external supply voltage from a host, the method comprising:
receiving a request from the host and identifying one or more selected flash memories associated with the request; and
selectively supplying the external supply voltage to the one or more selected flash memories via a switch.

13. The method of claim 12, further comprising:
cutting off supply of the external supply voltage to unselected flash memories.

14. The method of claim 13, wherein identification of the one or more selected flash memories results in the activation of corresponding chip selection signals associated with the selected flash memories and deactivation of chip selection signals associated with the unselected flash memories.

15. The method of claim 12, further comprising:
upon determining that all of the chip selection signals have been deactivated for a predetermined period of time, generating an interrupt to the host.

16. The method of claim 15, wherein the host cuts off the external supply voltage in response to the interrupt received from the memory controller.
